(19) United States
(12) Patent Application Publication
(10) Pub. No.: US 2025/0117136 A1
(43) Pub. Date: Apr. 10, 2025

(54) STORAGE DEVICE AND OPERATION METHOD THEREOF

(71) Applicant: SK hynix Inc., Gyeonggi-do (KR)

(72) Inventor: Kyu Ho CHOI, Gyeonggi-do (KR)

(21) Appl. No.: 18/443,313

(22) Filed: Feb. 16, 2024

(30) Foreign Application Priority Data
Oct. 6, 2023 (KR) 10-2023-0133015
Oct. 6, 2023 (KR) 10-2023-0133016

(51) Int. Cl. G06F 3/06

(52) U.S. Cl. CPC G06F 3/0613; G06F 3/0659; G06F 3/0673

(57) ABSTRACT

Embodiments of the present disclosure relate to a storage device and more particularly to a storage device which processes data for each zone in a device implemented with zone storage, and an operation method of the storage device. According to the embodiments of the present disclosure, remaining blocks generated in each zone are collected and set to an over provisioning area, so that a storage space can be efficiently used. According to the embodiments of the present disclosure, data is separated and written to different zones. Also, zone compression is performed on the data written to a specific zone, so that the storage space of the zone storage can be efficiently used.

### CROSS-REFERENCE TO RELATED APPLICATIONS

This patent application claims priority to Korea Patent Application No. 10-2023-0133015 filed on Oct. 6, 2023, and Korea Patent Application No. 10-2023-0133016 filed on Oct. 6, 2023, the entire disclosures of which are incorporated herein by reference for all purposes.

### FIELD

Embodiments of the present disclosure relate to a storage device and more particularly to a storage device which processes data for each zone in a device implemented with zone storage, and an operation method of the storage device.

### BACKGROUND

A storage device is capable of storing data on the basis of requests from a computer, a mobile terminal such as a smartphone, a tablet PC, etc., and a host such as various electronic devices.

The storage device may include a controller for controlling a memory (e.g., volatile memory and non-volatile memory). Such a controller receives commands from the host and performs or controls operations to read, write, or erase data in the memory included in the storage device based on the received commands.

Recently, a paradigm for the computer environment is shifting to ubiquitous computing, which allows a computer system to be used anytime and anywhere. As a result, a mobile device such as a mobile phone, a digital camera, a laptop computer, etc., are being rapidly and increasingly used. Such a mobile device generally uses a memory system that uses a storage device, that is, a data storage device. The data storage device is used as a main memory or an auxiliary memory in a portable electronic device.

Recently, in a flash memory (e.g., universal flash storage (UFS)), a flash memory (e.g., zone universal flash storage (ZUFS)) using zone storage technology has been proposed. The zone storage technology divides a memory into a plurality of zones, separates data into multiple data entries based on different purposes and frequencies of use, and stores the multiple data entries in different zones of the plurality of zones, so that the efficiency of data management is improved. However, the zone storage technology generally writes data to consecutive addresses in each zone, and does not allow the data to be truncated and written at the boundary of the zone, so that some areas at the end of each zone may not be used.

### SUMMARY

Embodiments of the present disclosure provide a storage device which processes data for each zone in a device implemented with zone storage, and an operation method of the storage device.

Embodiments of the present disclosure provide a storage device which uses remaining blocks generated for each zone, and an operation method of the storage device.

Embodiments of the present disclosure provide a storage device which performs, at a certain point in time, zone compression on data written to a specific zone, and an operation method of the storage device.

The technical concern to be overcome is not limited to the above-mentioned technical concerns. Other technical concerns not mentioned can be clearly understood from those described below by a person having ordinary skill in the art.

One embodiment of the present disclosure is a storage device including a memory and a memory controller configured to divide the memory into a plurality of zones, assign at least one unit zone to each of the plurality of zones, store data received from an external device in a first zone among the plurality of zones, store the data in a first unit zone when the first unit zone is in a zone open state and is included in the first zone and the data is able to be stored in a first unit zone, when the data is not able to be stored in the first unit zone, change a state of the first unit zone to a zone finish state, assign a second unit zone in the zone open state to the first zone, and store the data in the second unit zone, and determine remaining blocks which are empty blocks and present in the unit zones in the zone finish state and set the determined remaining blocks as an over-provisioning area.

Another embodiment of the present disclosure is an operation method of a memory controller. The operation method includes dividing a memory into a plurality of zones, assigning at least one unit zone to each of the plurality of zones, storing data received from an external device in a first zone among the plurality of zones, and determining, as an over-provisioning area, remaining blocks which are empty blocks and present in the unit zones in a zone finish state. The storing data received from an external device in the first zone among the plurality of zones includes storing the data in a first unit zone when the first unit zone is in a zone open state and is included in the first zone and the data is able to be stored in the first unit zone and when the data is not able to be stored in the first unit zone, changing a state of the first unit zone to the zone finish state, assigning a second unit zone in the zone open state to the first zone, and storing the data in the second unit zone.

Still another embodiment of the present disclosure is a storage device including a memory and a memory controller configured to divide the memory into a plurality of characteristic zones and assign at least one unit zone to each of the plurality of characteristic zones, store data received from an external device in a characteristic zone among the plurality of characteristic zones, receive zone compression activation setting information from the external device, and compress the data of the characteristic zone in which the zone compression activation is set.

Yet another embodiment of the present disclosure is an operation method of a memory controller. The operation method includes: assigning each unit zone to one of a plurality of characteristic zones, wherein a memory storage area is divided into a plurality of unit zones, storing data received from an external device in one or more characteristic zones of the plurality of characteristic zones, receiving zone compression activation setting information from the external device and compressing data stored in a characteristic zone in which the zone compression activation is set among the plurality of characteristic zones, based on the zone compression activation setting information.

According to the embodiments of the present disclosure, remaining blocks generated in each zone are collected and set to an over provisioning area, so that a storage space can be efficiently used.

According to the embodiments of the present disclosure, data is separated and written to different zones, so that the efficiency of data management is improved. Also, zone compression is performed on the data written to a specific zone, so that the storage space of the zone storage can be efficiently used.

### BRIEF DESCRIPTION OF THE DRAWINGS

FIG. 1 shows schematically a configuration of a storage device according to the embodiments of the present disclosure;

FIG. 2 is a diagram for describing a type zone and a unit zone according to the embodiments of the present disclosure;

FIG. 3 is a diagram for describing a data characteristic zone and a unit zone according to the embodiments of the present disclosure;

FIG. 4 is a flowchart for describing a zone compression operation in a zone storage device according to the embodiments of the present disclosure;

FIG. 5 is a diagram for describing a process of compressing data written to a cold zone according to the embodiments of the present disclosure;

FIG. 6 is a diagram for describing a process of compressing the data when the data written to the cold zone was transferred to another address area according to the embodiments of the present disclosure;

FIG. 7 is a diagram for describing using the unit zone in which the data according to the embodiments of the present disclosure has been compressed;

FIG. 8 is a flowchart for describing a process of storing the data in the storage device divided into the zones according to the embodiments of the present disclosure;

FIG. 9 is a flowchart for describing a process of processing remaining blocks present in each zone according to the embodiments of the present disclosure; and

FIG. 10 is a diagram for describing processing the remaining blocks present in each zone according to the embodiments of the present disclosure.

### DETAILED DESCRIPTION

Hereinafter, embodiments of the present disclosure will be described in detail with reference to the accompanying drawings.

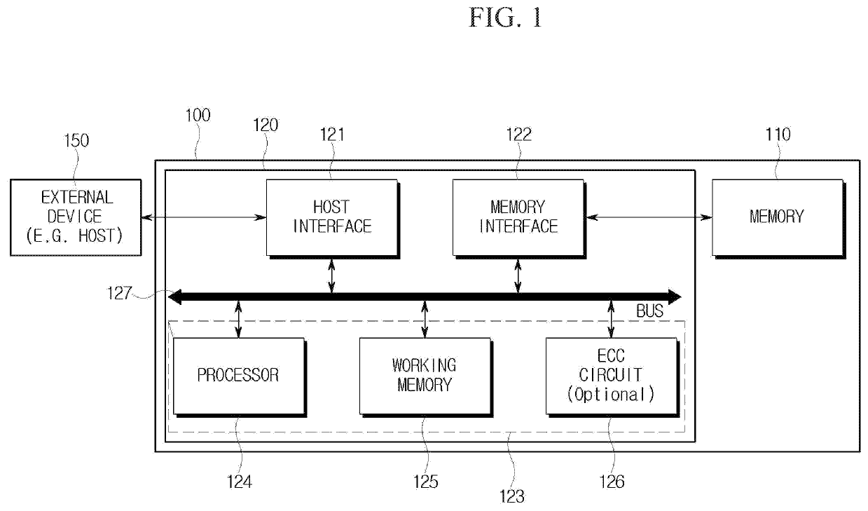

FIG. 1 shows schematically a configuration of a storage device 100 according to embodiments of the present disclosure.

Referring to FIG. 1, the storage device 100 according to the embodiment of the present disclosure may include a memory 110 that stores data, and a controller 120 that controls the memory 110.

The memory 110 operates in response to the control of the controller 120. Here, the operation of the memory 110 may include, for example, a read operation, a program operation (also, referred to as a write operation), and an erase operation.

For example, the memory 110 may be implemented as various types of memories such as double data rate synchronous dynamic random access memory (DDR SDRAM), low power double data rate 4 (LPDDR4) SDRAM, graphics double data rate (GDDR) SDRAM, low power DDR (LPDDR), Rambus dynamic random access memory (RDRAM), NAND flash memory, 3D NAND flash memory, NOR flash memory, resistive random access memory (RRAM), phase change random access memory (PRAM), magnetoresistive random access memory (MRAM), ferroelectric random access memory (FRAM), or spin transfer torque random access memory (STT-RAM).

The memory 110 may be implemented to have a three-dimensional array structure. The embodiments of the present disclosure can be applied not only to a flash memory in which a charge storage layer is composed of a conductive floating gate, but also to a charge trap type flash (CTF) in which the charge storage layer is composed of an insulation layer.

The memory 110 may receive commands and addresses from the controller 120 and may access an area in a memory cell array selected by an address. That is, the memory 110 may perform an operation indicated by a command with respect to the area selected by the address.

For example, the memory 110 may perform a program operation, a read operation, and an erase operation. During the program operation, the memory 110 may program data in the area of the memory cell array selected by the address. During the read operation, the memory 110 may read data from the area of the memory cell array selected by the address. During the erase operation, the memory 110 may erase data stored in the area of the memory cell array selected by the address.

The controller 120 may control the write (program), read, erase, and background operations on the memory 110. Here, the background operation may include but are not limited thereto, for example, one or more of garbage collection (GC), wear leveling (WL), read reclaim (RR), bad block management (BBM), hyper write migration, and SLC through migration operations.

The controller 120 may control the operation of the memory 110 in accordance with a request from an external device (e.g. a host (HOST)) 150 located outside the storage device 100. The controller 120 may control the operation of the memory 110 independently from the request from the external device 150.

The external device 150 may include a computer, an ultra-mobile PCs (UMPCs), a workstation, a personal digital assistant (PDAs), a tablet PC, a mobile phone, a smart phone, an e-book, a portable multimedia player (PMP), a portable game machine, a navigation system, a black box, a digital camera, a digital multimedia broadcasting (DMB) player, a smart television, a digital audio recorder, a digital audio player, a digital picture recorder, a digital picture player, a digital video recorder, a digital video player, a storage forming a data center, one of various electronic devices constituting a home network, one of various electronic devices constituting a computer network, one of various electronic devices constituting a telematics network, a radio frequency identification (RFID) device, or a mobile device (e.g., a vehicle, a robot, a drone) that travels on the ground, in the water or in the air under human control or autonomously.

The external device 150 may include at least one operating system (OS). The operating system can manage and control overall functions and operations of the external device, and can provide mutual operations between the external device and the storage device 100. The operating system may be divided into a general operating system and a mobile operating system, depending on the mobility of external devices.

The controller 120 and the external device 150 may be separated from each other. In some cases, the controller 120 and the external device 150 may be implemented as one integrated device. Hereinafter, an example will be described in which the controller 120 and the external device 150 are separated from each other.

Referring to FIG. 1, the controller 120 may include a memory interface 122 and a control circuit 123, and may further include a host interface 121.

The host interface 121 provides an interface for communicating with the external device 150. For example, the host interface 121 provides an interface that uses at least one of various interface protocols such as a universal serial bus (USB) protocol, a multimedia card (MMC) protocol, a peripheral component interconnection (PCI) protocol, a PCI-express (PCI-e or PCIe) protocol, an advanced technology attachment (ATA) protocol, Serial-ATA protocol, a Parallel-ATA protocol, a small computer system interface (SCSI) protocol, an enhanced small disk interface (ESDI) protocol, an integrated drive electronics (IDE) protocol, or a proprietary protocol.

When receiving a command from the external device 150, the control circuit 123 may receive the command through the host interface 121 and may perform an operation of processing the received command.

The memory interface 122 may be connected to the memory 110 to provide an interface for communicating with the memory 110. That is, the memory interface 122 may be configured to provide an interface between the memory 110 and the controller 120 in response to control of the control circuit 123.

The control circuit 123 controls the operation of the memory 110 by performing overall control operations of the controller 120. To this end, for example, the control circuit 123 may include at least one of a processor 124, and a working memory 125, and may selectively include an error detection and correction circuit (ECC) 126.

The processor 124 may control overall operations of the controller 120 and may perform logical operations. The processor 124 may communicate with the external device 150 through the host interface 121 and may communicate with the memory 110 through the memory interface 122.

The processor 124 may perform a function of a flash translation layer (FTL). The processor 124 may map a logical block address (LBA) provided by the external device 150 to a physical block address (PBA) through the flash translation layer (FTL). Through use of a mapping table, the flash translation layer (FTL) may receive the logical block address (LBA) and may map the logical block address to the physical block address (PBA).

There are various address mapping methods of the flash translation layer depending on a mapping unit. Representative address mapping methods include a page mapping method, a block mapping method, and a hybrid mapping method.

The processor 124 may randomize data received from the external device 150. For example, the processor 124 may randomize data received from the external device 150 by using a set randomizing seed. The randomized data may be provided to the memory 110 and programmed into the memory cell array of the memory 110.

The processor 124 may de-randomize the data received from the memory 110 during the read operation. For example, the processor 124 may de-randomize the data received from the memory 110 by using a de-randomizing seed. The de-randomized data may be output to the external device 150.

According to an embodiment, the processor 124 includes an application specific integrated circuit (ASIC) where the above-described functions are implemented in the form of logic. The processor 124 can control the operation of the controller 120 on the basis of the functions implemented in hardware.

According to another embodiment, the processor 124 includes a general-purpose processor or a digital signaling processor (DSP), and may control the operation of the controller 120 by loading and executing firmware. In order to control overall operations of the controller 120 and perform logical operations, the processor 124 may execute (drive) firmware loaded into the working memory 125 during booting.

For example, the firmware may include a flash translation layer (FTL), a host interface layer (HIL), and a flash interface layer (FIL). The flash translation layer (FTL) performs a translation function between a logical address that the external device requests from the storage device 100 and a physical address of the memory 110. The host interface layer (HIL) interprets a command requested from the storage device 100 by the external device 150 and transmits the command to the flash translation layer (FTL). The flash interface layer (FIL) transmits the command instructed by the flash translation layer (FTL) to the memory 110.

Such firmware may be, for example, loaded into the working memory 125 from the memory 110 or a separate non-volatile memory (e.g., ROM, NOR Flash) located outside the memory 110. When executing booting after power-on, the processor 124 may first load all or part of the firmware into the working memory 125.

The processor 124 may perform a logic operation defined in the firmware loaded into the working memory 125 to control the overall operation of the controller 120. The processor 124 may store a result of performing the logic operation defined in the firmware in the working memory 125. The processor 124 may control the controller 120 to generate a command or signal in accordance with the result of performing the logic operation defined in the firmware. When the part of the firmware in which the logic operation to be performed is defined is not loaded into the working memory 125, the processor 124 may generate an event (e.g., interrupt) for loading the corresponding part of the firmware into the working memory 125.

The processor 124 may load, from the memory 110, meta data required to drive the firmware. The meta data is for managing the memory 110 and may include management information on user data stored in the memory 110.

The firmware may be updated while the storage device 100 is being produced or while the storage device 100 is running. The controller 120 may download new firmware from the outside of the storage device 100 and may update the existing firmware to the new firmware.

The working memory 125 may store firmware, program codes, commands, or data required to drive the controller 120. The working memory 125 may include, for example, a volatile memory such as one or more of a static RAM (SRAM), a dynamic RAM (DRAM), and a synchronous DRAM (SDRAM).

The error detection and correction circuit 126 may detect an error bit of a target data by using an error correction code and may correct the detected error bit. Here, the target data may be, for example, data stored in the working memory 125 or data read from the memory 110.

The error detection and correction circuit 126 may be implemented to decode data with the error correction code. The error detection and correction circuit 126 may be implemented with a variety of code decoders. For example, a decoder that performs non-systematic code decoding or a decoder that performs systematic code decoding may be used.

A bus 127 may be configured to provide a channel between the components 121, 122, 124, 125, and 126 of the controller 120. Such a bus 127 may include, for example, a control bus for transmitting various control signals, and commands, and a data bus for transmitting various data.

Some of the aforementioned components 121, 122, 124, 125, and 126 of the controller 120 may be removed, or some of the aforementioned components 121, 122, 124, 125, and 126 of the controller 120 may be integrated into one. In some cases, in addition to the above-described components of the controller 120, one or more other components may be added.

The storage device 100 may store data in the memory 110. The basic unit of data storage in the memory 110 is a cell, and a plurality of cells may be collected together to form a page that is a minimum unit of data read and write operations. A block may include a plurality of pages and may be a minimum unit of the erase operation. A plurality of blocks is collected together to form one plane, and the memory 100 may include a plurality of planes. Here, the cell may be a single-level cell (SLC) which can store only one bit of information, or a multi-level cell (MLC), a triple-level cell (TLC), a quad-level cell (QLC), which can store a plurality of bits of information.

For efficient storage and processing of data, the storage device 100 may divide a storage area of the memory 110 into a plurality of zones and process data associated with the plurality of zones. The plurality of zones may be distinguished according to various methods such as purpose or frequency of use. According to an embodiment, each zone may be randomly set, and the size of the zone may be dynamically changed. The zone may be set to include a portion of the total memory area in the memory 110. For example, a unit zone including a plurality of memory blocks may be set, and each of the plurality of set zones may include at least one unit zone.

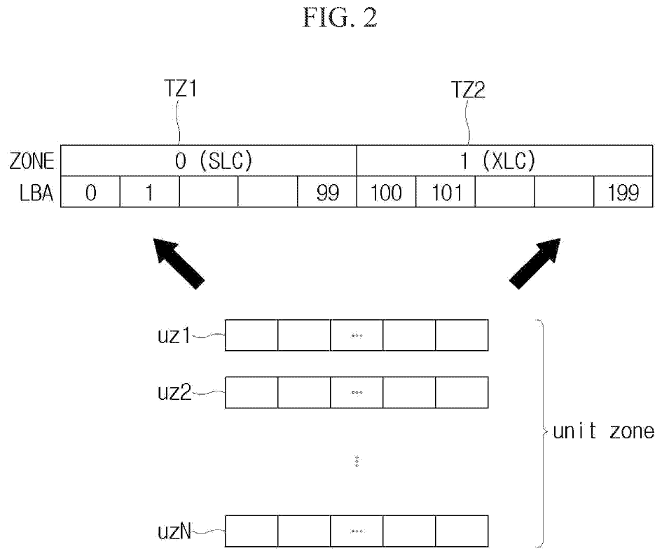

FIG. 2 is a diagram for describing the unit zone according to the embodiments of the present disclosure and a type zone that distinguishes the zone according to a data storage type of the cell.

Referring to FIG. 2, the controller 120 may set a plurality of unit zones uz1, uz2, . . . , uzN, each having specific size (e.g., 1 GB). Depending on the data storage type of the cell constituting the unit zone, a unit zone may be set to a first type zone TZ1, and another unit zone may be set to a second type zone TZ2.

The first type zone TZ1 includes one or more unit zones set as single-level cells (SLC) where each cell stores one bit of data. The second type zone TZ2 may include one or more unit zones set as X-level cells (XLC, where X indicates a specific integer among numbers greater than or equal to two) where each cell stores two or more bits of data. The X-level cell (XLC) may be one of a multi-level cell (MLC) where two bits of data is stored therein, a triple-level cell (TLC) where three bits of data is stored therein, and a quad-level cell (QLC) where four bits of data is stored therein.

According to an embodiment, the number of cells included in the unit zone corresponding to the first type zone TZ1 and the number of cells included in the unit zone corresponding to the second type zone TZ2 may be different from each other. The number of unit zones corresponding to the first type zone TZ1 and the number of unit zones corresponding to the second type zone TZ2 may also be different from each other and may be variable respectively.

In the following embodiments, the state of the unit zone may be divided into one of a plurality of states depending on the use of the zone or operation state of the zone. According to an embodiment, the state that the unit zone can have may include a zone open state and a zone finish state. The zone open state may be a state in which data write is possible. The zone finish state may be a state in which the data write is normally completed and is no longer possible.

In the present specification, a remaining block may refer to an empty block in which data has not been written in the unit zone in the zone finish state. The empty block may mean a block in which there is no page where data have been written.

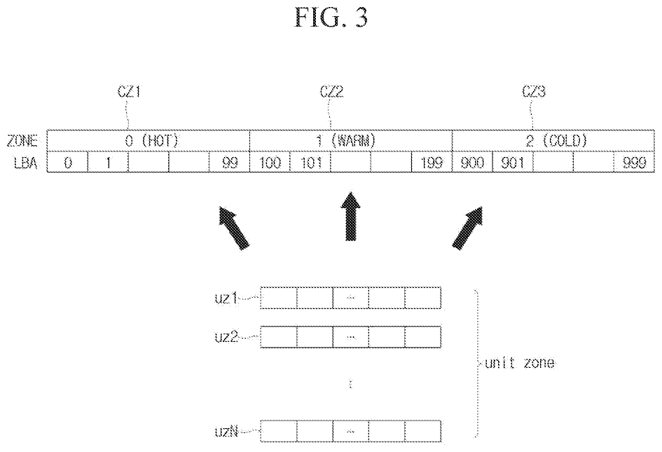

FIG. 3 is a diagram for describing the unit zone according to the embodiments of the present disclosure and a characteristic zone that distinguishes the zone according to characteristics of stored data.

Referring to FIG. 3, the controller 120 may set the plurality of unit zones uz1, uz2, . . . , uzN, each having a specific size (e.g., 1 GB).

Additionally, the controller 120 may set a plurality of characteristic zones CZ1, CZ2, and CZ3 according to the characteristics of the data stored in zone. Each of the characteristic zones CZ1, CZ2, and CZ3 may include at least one unit zone. According to an embodiment, the characteristics of the data may be divided into hot data HOT DATA, warm data WARM DATA, and cold data COLD DATA, according to characteristics of the read or write frequency of the corresponding data of the external device 150. According to an embodiment, when writing data, the external device 150 may provide, to the controller 120, data characteristic information which indicates whether the data is the cold data, warm data, or hot data. The controller 120 can hereby recognize the data characteristic information.

The first characteristic zone CZ1 may refer to a hot zone HOT where the hot data HOT DATA is written. The second characteristic zone CZ2 may refer to a warm zone WARM where the warm data WARM DATA is written. The third characteristic zone CZ3 may refer to a cold zone COLD where the cold data COLD DATA is written.

The controller 120 may receive, from the external device 150, a data write command including the data characteristic information. Further, the controller 120 may write the received data to a characteristic zone, among the plurality of characteristic zones, which corresponds to the received data characteristic information.

For example, when the controller 120 receives data and a write command including the data characteristic information indicating that the data is the hot data, the controller 120 may write the received data to the first characteristic zone (i.e., hot zone) CZ1. When the controller 120 receives a write command including the data characteristic information indicating that the data is the cold data, the controller 120 may write the received data to the third characteristic zone (i.e., cold zone) CZ3.

In some embodiments, the controller 120 may set the plurality of characteristic zones according to a cell type. For example, the controller 120 may set the hot zone CZ1 and warm zone CZ2 to include a unit zone composed of single-level cells (SLC) and may set the cold zone CZ3 to include a unit zone composed of triple-level cells (TLC). The hot zone CZ1 and warm zone CZ2 may be set to the first type zone TZ1, and the cold zone CZ3 may be set to the second type zone TZ2. However, this setting is based on the embodiment, and each characteristic zone may be set according to various methods (e.g., mixing the single-level cells and triple-level cells).

According to an embodiment, the numbers of unit zones included in the hot zone CZ1, warm zone CZ2, and cold zone CZ3 respectively may be different from each other, and the number of unit zones included in the hot zone CZ1, warm zone CZ2, or cold zone CZ3 may be variable. For example, at least one unit zone corresponding to the characteristic zone is not assigned in advance, and whenever a specific characteristic zone is required, a new unit zone may be assigned to the corresponding characteristic zone. Accordingly, the sizes of the characteristic zones may be different from each other and may change over time. In some embodiments, each of the hot zone CZ1, warm zone CZ2, and cold zone CZ3 may be divided into a data zone and a node zone. The data zone is a zone where the data is stored, and the node zone is a zone where the metadata of the data is stored. Therefore, the hot zone CZ1 may be divided into a hot data zone and a hot node zone, and the warm zone CZ2 may be divided into a warm data zone and a warm node zone. Also, the cold zone CZ3 may be divided into a cold data zone and a cold node zone.

According to an embodiment of the present disclosure, since the controller 120 can recognize the characteristics of the stored data, the storage space of the storage device 100 can be efficiently used.

The controller 120 can efficiently use the storage space by performing compression on the data stored in at least one of the hot zone CZ1, warm zone CZ2, and cold zone CZ3.

After a user of the external device 150 views multimedia data such as a movie once, the user is highly unlikely to view it again. Therefore, the multimedia data may be classified as the cold data because a frequency at which the external device 150 accesses the multimedia data is low. Hereinafter, a method of performing zone compression when the cold data such as multimedia is stored in the cold zone will be described in an embodiment.

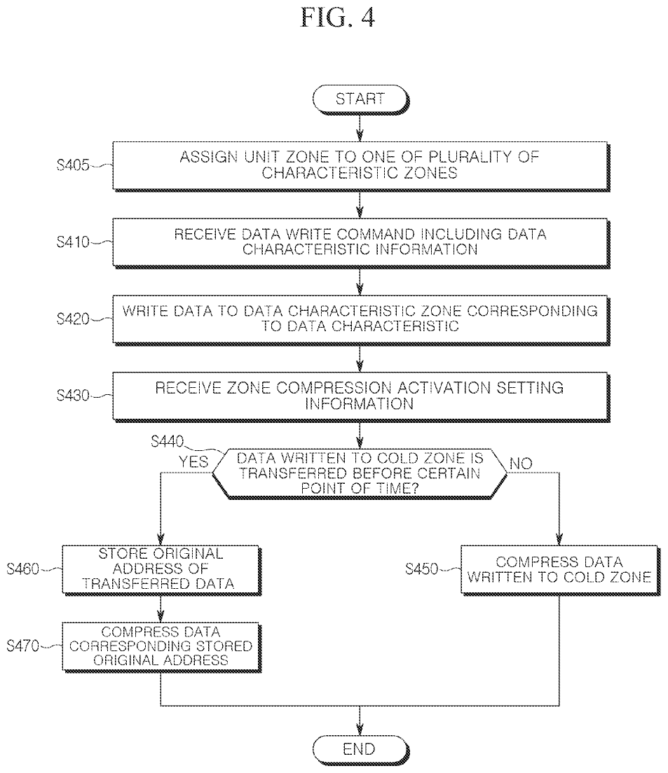

FIG. 4 is a flowchart for describing a zone compression operation in a zone storage device according to the embodiments of the present disclosure.

The controller 120 may divide the memory 110 into the plurality of different characteristic zones, and each of the plurality of characteristic zones may include at least one unit zone. The controller 120 may assign the unit zone to one of the plurality of characteristic zones (S405). The controller 120 may receive, from the external device 150, a data write command including the data characteristic information (S410). That is, the external device 150 may provide the controller 120 with information indicating whether the data is the hot data, warm data, or cold data.

The controller 120 may actively set a characteristic zone corresponding to the data characteristic information among the plurality of characteristic zones and may write data to the set specific characteristic zone (S420). According to another embodiment, at least one of the plurality of characteristic zones may be set in advance before the data is received. For example, when the external device 150 requests the storage device 100 to set the zone, the controller 120 may set a characteristic zone corresponding to the data characteristic information. The controller 120 may store the data in the characteristic zone which is set in advance and corresponds to the data characteristic information. Also, if a remaining area of the characteristic zone set in advance is insufficient to store the data, the external device 150 may additionally set a characteristic zone corresponding to the data characteristic information.

The controller 120 may receive zone compression activation setting information from the external device 150 (S430). When the zone compression activation is set, all data written to the zone can be compressed.

According to an embodiment, the external device 150 may transmit the zone compression activation setting information through a command of an interface protocol (e.g., UFS) applied between the external device 150 and the storage device 100. For example, the external device 150 may transmit, to the storage device 100, a command for enabling forced refresh.

Hereinafter, in an embodiment, a case where zone compression activation is set only in the cold zone will be described.

The data written to a cold zone in the zone finish state may be transferred to another address area before a certain point in time (e.g., before a refresh operation is performed) due to garbage collection or wear leveling. For example, the data written to a cold zone may be transferred to another cold zone or another hot zone.

In this case, the controller 120 may store an original address of the data transferred to another address area and may compress the data transferred to another address area at the certain point in time (S440, S460, S470). An example of a method of storing the original address includes tagging.

In this case, the external device 150 may separately transmit, to the controller 120, information on the certain point in time when the controller 120 performs the zone compression or may not separately transmit the information on certain point in time.

When the external device 150 does not separately transmit the information on certain point in time to the controller 120, the controller 120 may compress the data written to the cold zone at a predetermined certain point in time (e.g., a refresh time point).

When the data written to the cold zone is not transferred, the controller 120 may compress the data which has been written to the cold zone at a certain point in time (S440, S450).

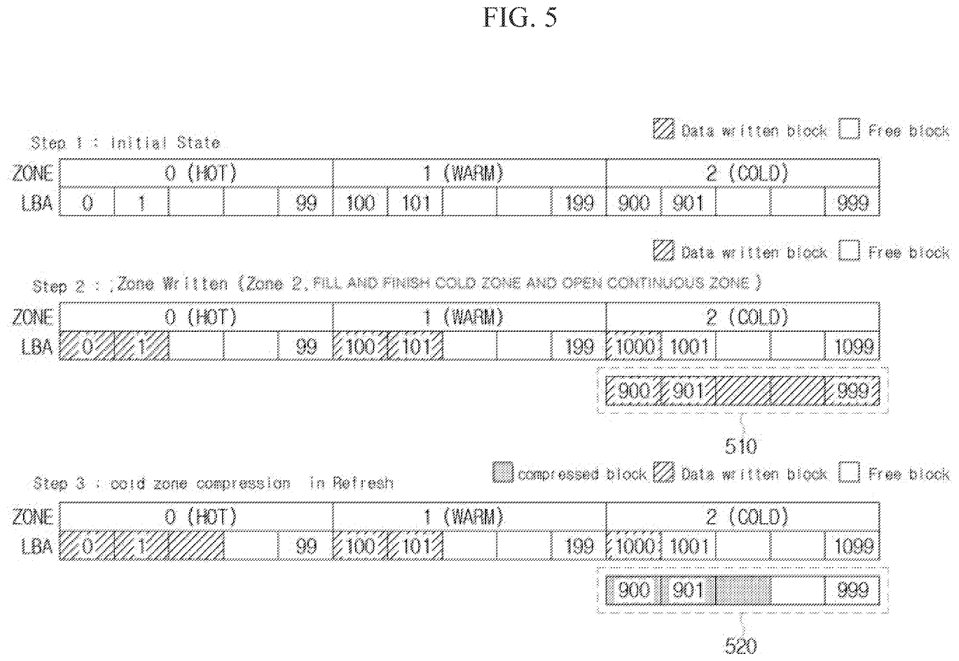

FIG. 5 is a diagram for describing a process of compressing the data written to the cold zone according to the embodiments of the present disclosure. In FIG. 5, LBA means logical block address (LBA).

First, in operation 1 (Initial State), when a data write command is received from the external device 150, the controller 120 sequentially sets the zone open state to each unit zone of the hot zone, warm zone, and cold zone. For example, first, the zone open state may be set to a first unit zone.

In operation 2 (Zone Written), the controller 120 may write data to the characteristic zone corresponding to the data characteristic received from the external device 150. According to an embodiment, the controller 120 may write the received data to an open unit zone included in the corresponding characteristic zone. The controller 120 writes data to the open unit zone included in the corresponding characteristic zone. When the controller 120 can no longer write data to the corresponding unit zone or the size of the data to be currently written is greater than the remaining area in the corresponding unit zone, the controller 120 may change the unit zone to the zone finish state and may set a new unit zone to the zone open state. For example, when data is written to a first zone (addresses 900 to 999) included in the cold zone and then data can no longer be written to the first zone (e.g., data is written to all areas of the first zone) or the size of the data to be currently written is greater than the remaining area in the first zone, the controller 120 may change the first zone to the zone finish state 510 in accordance with a zone finish command received from the external device 150 and may set a second zone (addresses 1000 to 1099) to the zone open state.

In operation 3 (cold zone compression in refresh), the controller 120 may compress, at a certain point in time, data written to the unit zone in the zone finish state among the unit zones included in the cold zone (e.g., a preset point in time at which refresh is performed). According to an embodiment, when the data has been already compressed, compression may not be performed on the corresponding unit zone even when the refresh time point arrives.

When the compression is performed, the size of the data written to the corresponding unit zone may be reduced as shown in the drawing (520).

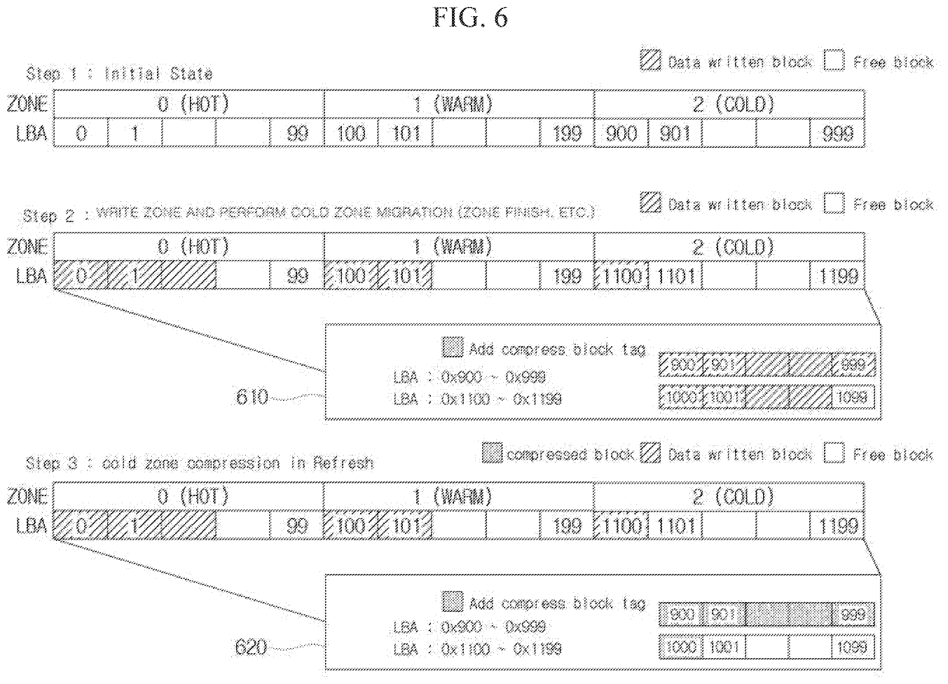

FIG. 6 is a diagram for describing a process of compressing the data when the data written to the cold zone according to the embodiments of the present disclosure is transferred to another address area.

First, in operation 1 (initial state), the controller 120 sets the zone open state to each unit zone of the hot zone, warm zone, and cold zone. For example, first, the zone open state may be set to the first unit zone.

In operation 2 (Zone Written and Cold Zone Migration), the controller 120 may write data to the characteristic zone corresponding to the data characteristic received from the external device 150. According to an embodiment, the controller 120 may write the received data to an open unit zone included in the corresponding characteristic zone. The controller 120 writes data to the open unit zone included in the corresponding characteristic zone. When the corresponding unit zone is completely filled, the controller 120 may change the unit zone to the zone finish state and may set a new unit zone to the zone open state. For example, when data is written to the first zone (addresses 900 to 999) and the second zone (addresses 1000 to 1099) included in the cold zone and the data is written to all areas of the first and second zones, the controller 120 may change the first zone and the second zone to the zone finish state and may set a third zone (addresses 1100 to 1199) to the zone open state.

After data is completely filled in a random cold zone, due to garbage collection or wear leveling, which is performed depending on the state of the storage device 100, the data in the corresponding cold zone may be transferred to another address area before a certain point in time (e.g., before a refresh operation is performed). For example, the data may be transferred to a data hot zone which is a unit zone of the cold zone and which is written in the first zone (addresses 900 to 999) and the second zone (addresses 1000 to 1099).

In this case, the controller 120 may tag an original address of the data written to the first zone (addresses 900 to 999) and the second zone (addresses 1000 to 1099) which are the unit zones of the cold zone (610). Here, the original address of the data may be a physical address.

In operation 3 (cold zone compression in refresh), when the refresh time point arrives for data having the tagged address, the controller 120 may perform compression even though the data is not currently stored in the cold zone. When the compression is performed, the size of the transferred data is reduced (620).

According to an embodiment of the present disclosure, the controller 120 can efficiently utilize space by using the unit zone where the compression has been performed.

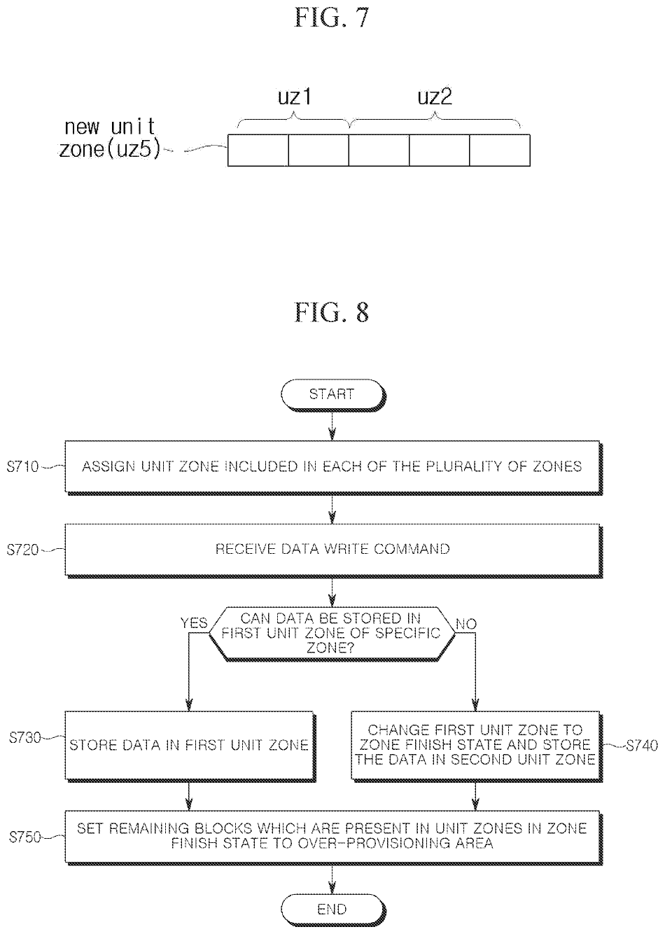

FIG. 7 is a diagram for describing using the unit zone in which the data according to the embodiments of the present disclosure has been compressed.

As shown, the controller 120 may set a unit zone uz5, that is, a new unit zone, by combining a unit zone uz1 and a unit zone uz2, in which remaining blocks have been formed by compression. In this case, the controller 120 may generate and store information such as a data structure connecting the unit zone uz1 and the unit zone uz2 which constitute the unit zone uz5. The size of the unit zone uz5, that is, a new unit zone, may be the same as those of the unit zone uz1 and the unit zone uz2. For example, in a case where, by compression, a first number of remaining blocks is formed in the unit zone uz1 and a second number of remaining blocks is formed in the unit zone uz2, when a sum of the first number and the second number is greater than or equal to the number of blocks constituting one unit zone, the unit zone uz5, that is, a new unit zone, may be set by combining the remaining blocks of the unit zone uz1 and the remaining blocks of the unit zone uz2.

While the remaining block of the unit zone may be formed by compression, the remaining block may be formed in each unit zone depending on the size of data written to each unit zone, regardless of the zone compression. For example, if the size of the data to be currently written is greater than that of an empty area remaining in the zone, the zone may become in the zone finish state, and the empty area without data written in the zone may become a remaining block. Thus, the formed remaining block may cause management costs and waste of the storage space of the storage device 100.

FIG. 8 is a flowchart for describing a process of storing data in the storage device divided into the zones according to the embodiments of the present disclosure.

The controller 120 may divide the memory 110 into a plurality of zones, and each of the plurality of zones may include at least one unit zone. The controller 120 can assign a unit zone included in each of the plurality of zones (S710).

The controller 120 may receive a data write command from the external device 150 (S720).

The controller 120 may store data in a specific zone among the plurality of zones according to the received write command.

In this case, if the data can be stored in a first unit zone in the zone open state which is included in the specific zone, the controller 120 may store the data in the first unit zone (S730).

If the data cannot be stored in the first unit zone in the zone open state which is included in the specific zone, the controller 120 may change, based on the zone finish command received from the external device 150, the first unit zone to the zone finish state, may assign a second unit zone in the zone open state and include the second unit zone in the first zone, and may store the data in the second unit zone (S740).

The controller 120 may collect (or determine) remaining blocks which are empty blocks without stored data and present in the unit zones in the zone finish state to form a new unit zone, and may set the new unit zone as an over-provisioning area (S750). Hereinafter, a method for processing the remaining blocks to prevent or improve the above-mentioned management costs and waste of the storage space will be described.

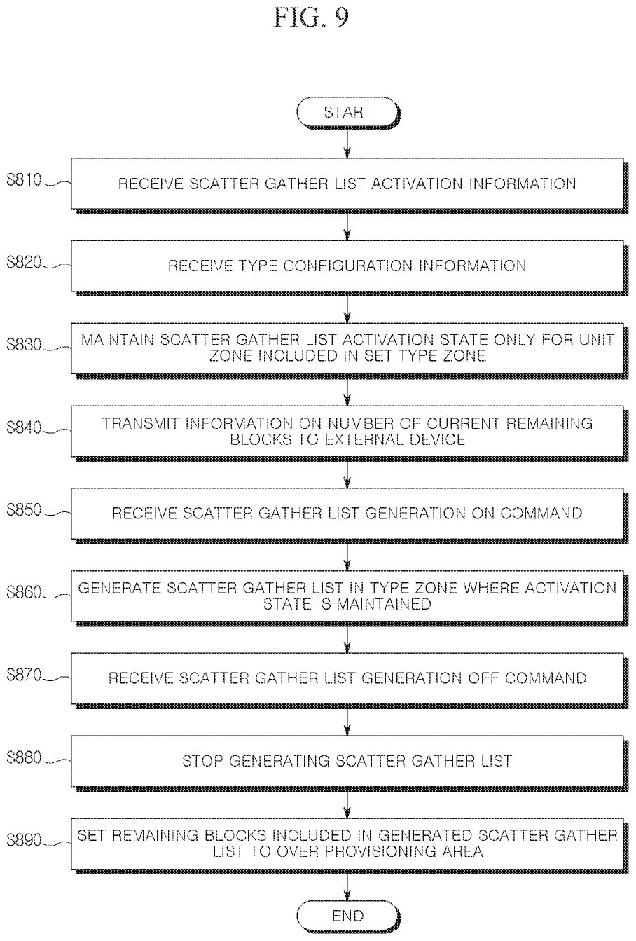

FIG. 9 is a flowchart for describing a process of processing the remaining blocks present in each zone according to the embodiments of the present disclosure.

The controller 120 may receive scatter gather list (SGL) activation information from the external device 150 (S810). The external device 150 may transmit, to the controller 120, a single command for activating a scatter gather list. Alternatively, the external device 150 may transmit, to the controller 120, a specific command including the scatter gather list activation information. When “enable” is included in the scatter gather list activation information, the controller 120 may maintain a state in which the scatter gather list can be generated. When “disable” is included in the scatter gather list activation information, the controller 120 may maintain a state in which the scatter gather list is not generated.

If a use capacity of the storage device 100 exceeds a predetermined amount (e.g., 90%), the external device 150 may transmit the activation information to the controller 120 by using a reserved field in the specific command or by using the single command.

When receiving the activation information from the external device 150, the controller 120 may also receive type configuration information of the scatter gather list (SGL) (S820).

The type configuration information of the scatter gather list may be used to activate the scatter gather list only for a specific zone. The type configuration information of the scatter gather list is for specifying a specific zone in which the scatter gather list is generated.

The controller 120 may maintain a scatter gather list activation state only for the unit zone included in the type zone set according to the received type configuration information (S830).

For example, when the controller 120 receives, from the external device 150, the type configuration information (e.g., SLC SGL ENABLE) of the scatter gather list that supports only the first type zone TZ1, the controller 120 may maintain the scatter gather list activation state only for the first type zone TZ1. When the controller 120 receives, from the external device 150, the type configuration information (SLC+XLC (TLC/QLC) SGL ENABLE) of the scatter gather list that supports both the first type zone TZ1 and the second type zone TZ2, the controller 120 may maintain the scatter gather list activation state for both the first type zone TZ1 and the second type zone TZ1.

The controller 120 may transmit information on the number of remaining blocks currently present in each unit zone to the external device 150 (S840).

The external device 150 may transmit, to the controller 120, a scatter gather list (SGL) generation on command (SGL on) based on the information on the number of remaining blocks.

The external device 150 may not receive the information on the number of remaining blocks from the storage device 100 and may transmit a scatter gather list (SGL) generation on command (SGL on) based on the data use capacity of the storage device 100.

When the controller 120 receives the scatter gather list (SGL) generation on command (SGL on) from the external device 150, the controller 120 generates the scatter gather list for the type zone or data characteristic zone where the activation state is maintained (S850 and 860). Hereinafter, a method for generating the scatter gather list for the type zone where the activation state is maintained will be described.

In this case, when there is a plurality of type zones where the activation state is maintained, the controller 120 may separately generate the scatter gather list for each type zone.

The controller 120 may extract a physical address of a remaining block existing in each unit zone in the zone finish state and may collect the physical addresses of the extracted remaining blocks to generate the scatter gather list.

When the controller 120 receives, from the external device 150, a scatter gather list (SGL) generation off command (SGL off), the controller 120 may stop generating the scatter gather list (S880).

The controller 120 may set, as an over provisioning area, the remaining blocks corresponding to the physical addresses included in the generated scatter gather list (S890).

The over provisioning area may be used during the background operation. For example, the remaining blocks set as the over provisioning areas may be used during the garbage collection (GC) and the wear leveling (WL).

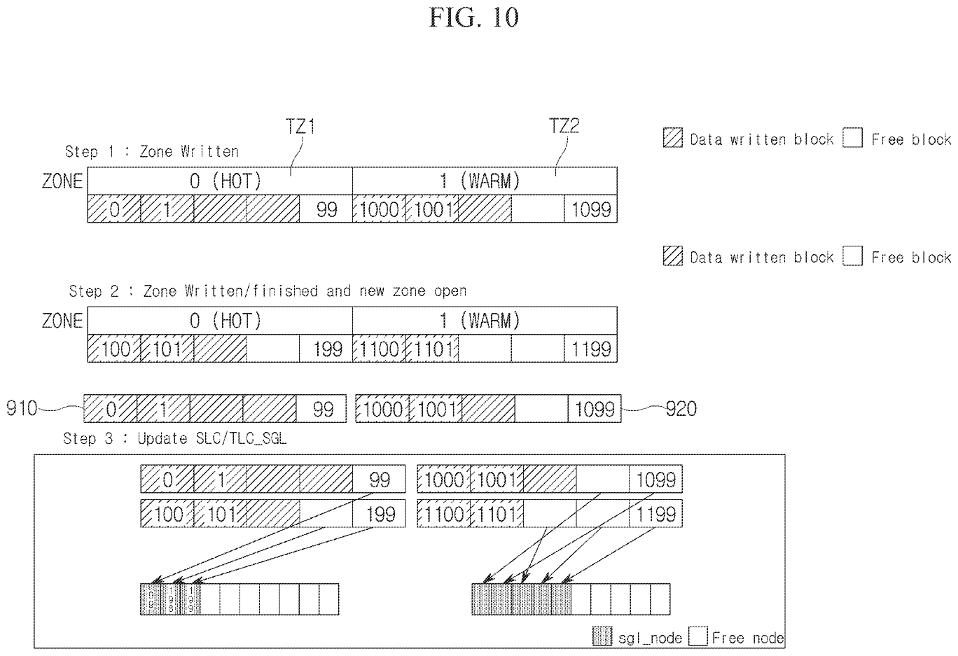

FIG. 10 is a diagram for describing processing the remaining blocks present in each zone according to the embodiments of the present disclosure. Hereinafter, an embodiment will describe a case where the unit zone of the first type zone TZ1 includes SLC and the unit zone of the second type zone TZ2 includes TLC.

First, in operation 1 (zone written), the controller 120 may set the zone open state and may write data for each type zone.

In operation 2 (zone written/finished and new zone open), when a specific unit zone included in the specific type zone is filled and becomes in the zone finish state after the controller 120 writes data for each type zone, the controller 120 sets a new unit zone to the zone open state.

Reference numerals 910 and 920 represent unit zones in the zone finish state.

In operation 3 (update SLC/TLC_SGL), the controller 120 may generate or update the scatter gather list separately for each type zone. For example, the scatter gather list of the first type zone TZ1 may extract the physical addresses (99, 199, . . . ) of the remaining blocks from the unit zone in the zone finish state included in the first type zone TZ1, and may generate the scatter gather list by combining the extracted physical addresses of the remaining blocks. Also, the scatter gather list of the second type zone TZ2 may extract the physical addresses ( . . . , 1099, . . . ) of the remaining block from the unit zone in the zone finish state included in the second type zone TZ2 and may generate the scatter gather list by combining the extracted physical addresses of the remaining blocks. Also, the controller 120 may set the remaining blocks corresponding to the physical addresses included in the scatter gather list generated as described above as an over provisioning area.

As described above, according to the embodiments of the present disclosure, management costs and storage space waste of the zone storage can be prevented or improved by processing the remaining blocks generated for each zone.

According to the embodiments of the present disclosure, the storage space can be efficiently utilized by collecting the remaining blocks generated for each zone and by setting the remaining blocks as the over-provisioning area.

According to the embodiments of the present disclosure, the storage space of the zone storage can be efficiently used by dividing data by characteristics, by writing them to different zones, and by performing zone compression on data written in a specific zone.

The foregoing is only an illustrative description of the spirit of the present invention. Various substitutions, modification and changes may be made therein without departing from the essential features of the present invention by those skilled in the art. Therefore, the embodiments and accompanying drawings of the present invention are not intended for limiting the spirit but intended for describing the spirit of the present invention, and the spirit and scope of the present invention are not limited by the embodiments and accompanying drawings. The scope of the present invention should be construed by the appended claims. All the spirits within the scope equivalent to the claims should be construed to be included in the scope of the present invention.

What is claimed is:

1. A storage device comprising:
a memory; and
a memory controller configured to:
divide the memory into a plurality of zones,
assign at least one unit zone to each of the plurality of zones,
store data received from an external device in a first zone among the plurality of zones,
store the data in a first unit zone when the first unit zone is in a zone open state and is included in the first zone and the data is able to be stored in the first unit zone,
when the data is not able to be stored in the first unit zone, change a state of the first unit zone to a zone finish state, assign a second unit zone in the zone open state to the first zone, and store the data in the second unit zone, and
determine remaining blocks which are empty blocks presented in the unit zones in the zone finish state, and set the determined remaining blocks as an over-provisioning area.

2. The storage device of claim 1, wherein the memory controller is configured to:
receive scatter gather list activation information from the external device, and
maintain a scatter gather list activation state according to the scatter gather list activation information.

3. The storage device of claim 2, wherein the memory controller is configured to:
receive a scatter gather list generation on command from the external device, and
generate a scatter gather list based on the scatter gather list generation on command.

4. The storage device of claim 3, wherein the memory controller is configured to:
extract physical addresses of the remaining blocks based on the scatter gather list generation on command,
generate the scatter gather list by collecting the extracted physical addresses, and
set areas corresponding to the physical addresses as the over provisioning area.

5. The storage device of claim 3, wherein the memory controller is configured to transmit a number of the remaining blocks to the external device.

6. The storage device of claim 4, wherein the memory controller is configured to:
divide the plurality of zones into a first type zone including a unit zone including single-level cells (SLC), and a second type zone including a unit zone including X-level cells (XLC), where X is an integer greater than or equal to two, and generate the scatter gather list for the first type zone and the second type zone.

7. The storage device of claim 6, wherein the memory controller is configured to:
receive, from the external device, type configuration information of the scatter gather list, and
maintain the scatter gather list activation state for the unit zone included in a zone specified by the received type configuration information.

8. The storage device of claim 7, wherein, when the type configuration information of the scatter gather list supports both the first type zone and the second type zone, the memory controller is configured to maintain the scatter gather list activation state for both the first type zone and the second type zone.

9. The storage device of claim 4, wherein the memory controller is configured to:
receive, from the external device, a scatter gather list generation off command, and
stop generating the scatter gather list according to the scatter gather list generation off command.

10. An operation method of a memory controller, the operation method comprising:
dividing a memory into a plurality of zones,
assigning at least one unit zone to each of the plurality of zones;
storing data received from an external device in a first zone among the plurality of zones; and
determining, as an over-provisioning area, remaining blocks which are empty blocks presented in the unit zones in a zone finish state,
wherein the storing data received from the external device in the first zone among the plurality of zones comprises:
storing the data in a first unit zone when the first unit zone is in a zone open state and is included in the first zone and the data is able to be stored in the first unit zone; and
when the data is not able to be stored in the first unit zone, changing a state of the first unit zone to the zone finish state, assigning a second unit zone in the zone open state to the first zone, and storing the data in the second unit zone.

11. A storage device comprising:
a memory; and
a memory controller configured to:
divide the memory into a plurality of characteristic zones,
assign at least one unit zone to each of the plurality of characteristic zones,
store data received from an external device in a characteristic zone among the plurality of characteristic zones,
receive zone compression activation setting information from the external device, and
compress the data of the characteristic zone in which the zone compression activation is set.

12. The storage device of claim 11, wherein a point in time when the compression is performed is set in advance.

13. The storage device of claim 11, wherein, after the zone compression activation is set, the memory controller is configured to receive, from the external device, information on a point in time when the compression is performed.

14. The storage device of claim 12, wherein the memory controller is configured to:
receive, from the external device, a data write command including characteristic information of the data, and
write the data to a characteristic zone among the plurality of characteristic zones, which corresponds to the characteristic information of the data.

15. The storage device of claim 14,
wherein the characteristic information of the data comprises hot data, warm data, and cold data which are divided according to characteristics of a read or write frequency of the external device, and
wherein the plurality of characteristic zones comprises a hot zone, a warm zone, and a cold zone which store the hot data, warm data, and cold data, respectively.

16. The storage device of claim 11,
wherein the unit zone comprises a unit zone in a zone open state and a unit zone in a zone finish state, and
wherein the memory controller is configured to compress data stored in the unit zone in the zone finish state among the unit zones of the characteristic zone in which the zone compression activation is set.

17. The storage device of claim 15, wherein the unit zone included in the cold zone includes X-level cells (XLC), where X is an integer greater than or equal to two.

18. The storage device of claim 16, wherein the memory controller is configured to:
set a new unit zone by using remaining blocks of the plurality of unit zones where the data compression is completed among the unit zones included in the characteristic zone in which the zone compression activation is set.

19. The storage device of claim 16, wherein, when the data written to the characteristic zone in which the zone compression activation is set is transferred to another address area before a point in time when the compression is performed, the memory controller is configured to store an original address of the data transferred to the another address area, and compress the data transferred to the another address area at the point in time when the compression is performed.
